(19) United States
(12) Patent Application Publication
(10) Pub. No.: US 2018/0197215 A1
(43) Pub. Date: Jul. 12, 2018

(54) BILLING SYSTEM, BILLING METHOD, AND RECORDING MEDIUM

(71) Applicants: Takashi TORIUMI, Kanagawa (JP); Yasunori TSUKIOKA, Kanagawa (JP); Shunsuke WATANABE, Tokyo (JP); Yuka KONNO, Kanagawa (JP); Katsumi TANAKA, Kanagawa (JP); Mie WATANABE, Tokyo (JP); Hirohisa SAITOH, Tokyo (JP); Hiroyuki SAKUYAMA, Tokyo (JP); Tohru SASAKI, Kanagawa (JP); Atsushi OKAZATO, Kanagawa (JP)

(72) Inventors: Takashi TORIUMI, Kanagawa (JP); Yasunori TSUKIOKA, Kanagawa (JP); Shunsuke WATANABE, Tokyo (JP); Yuka KONNO, Kanagawa (JP); Katsumi TANAKA, Kanagawa (JP); Mie WATANABE, Tokyo (JP); Hirohisa SAITOH, Tokyo (JP); Hiroyuki SAKUYAMA, Tokyo (JP); Tohru SASAKI, Kanagawa (JP); Atsushi OKAZATO, Kanagawa (JP)

(73) Assignee: RICOH COMPANY, LTD., Ohta-ku, Tokyo (JP)

(21) Appl. No.: 15/741,034

(22) PCT Filed: Jul. 11, 2016
(86) PCT No.: PCT/JP2016/003285

§ 371 Date: Dec. 29, 2017

(30) Foreign Application Priority Data
Jul. 24, 2015 (JP) 2015-147211

(51) Int. Cl. G06Q 30/04; H04N 1/00; H04N 1/32

(52) U.S. Cl. CPC G06Q 30/04; H04N 1/00323; H04N 1/32625; H04N 2201/0072; H04N 1/00474; H04N 2201/0094; H04N 2201/001; H04N 1/32678

(57) ABSTRACT

A billing system includes an operation unit, a determination unit, an extraction unit, a first calculator, and a second calculator. The operation unit receives an operation for executing a function provided by one device of a plurality of devices. The determination unit determines whether the one device is available for the function associated with the operation received by the operation unit. The extraction unit extracts another device that is available for the function as a substitute for the one device when the determination unit determines that the one device is not available for the function. The first calculator calculates a fee for the function to be executed by the other device. The second calculator calculates a total billed amount based on the fee calculated by the first calculator and content executed by the other device when the function is executed by the other device.

### TECHNICAL FIELD

The present invention relates to a billing system, a billing method, and a recording medium.

### BACKGROUND ART

Multifunction peripherals having a plurality of functions to serve as, for example, a facsimile, a printer, a copier, and a scanner are conventionally known.

There is a system that charges for usage of a multifunction peripheral on a usage basis as disclosed in PTL 1, for example. A user may configure such a system to include not only a multifunction peripheral but also single-function devices, such as a facsimile, a printer, a copier, and a scanner. A user will select and use a device suitable for purpose among the plurality of devices placed in an office.

### SUMMARY OF INVENTION

### Technical Problem

However, there can be a case where a user cannot use a desired function of a desired device due to a breakdown or the like. In this case, the user may desire to use a function, which is equivalent to the desired function, provided by another device even if the equivalent function differs from the desired function. However, conventionally, information about an alternative way that uses a substitute device and a fee therefor has not been provided to such a user.

In view of the above, there is a need for a billing system, a billing method, and a computer-readable recording medium that enable maintaining a user's satisfaction level even in a situation where a function of a device the user desires to use is unavailable.

### Solution to Problem

According to one aspect of the present invention, a billing system includes an operation unit, a determination unit, an extraction unit, a first calculator, and a second calculator. The operation unit is configured to receive an operation for executing a function provided by one device of a plurality of devices. The determination unit is configured to determine whether the one device is available for the function associated with the operation received by the operation unit. The extraction unit is configured to extract another device that is available for the function as a substitute for the one device when the determination unit determines that the one device is not available for the function. The first calculator is configured to calculate a fee for the function to be executed by the other device. The second calculator is configured to calculate a total billed amount based on the fee calculated by the first calculator and content executed by the other device when the function is executed by the other device as the substitute for the one device.

### Advantageous Effect of Invention

According to an aspect of the present invention, it is possible to maintain a user's satisfaction level even in a situation where a function of a device the user desires to use is unavailable.

### BRIEF DESCRIPTION OF DRAWINGS

FIG. 1 is a schematic diagram illustrating an example of a billing system of a present embodiment.

FIG. 2 is a block diagram illustrating an example of a hardware configuration of an MFP of the present embodiment.

FIG. 3 is an explanatory diagram illustrating an example of a function table.

FIG. 4 is an explanatory diagram illustrating an example of a fee table.

FIG. 5 is an explanatory diagram illustrating an example of a billing information table.

FIG. 6 is a block diagram illustrating an example of a hardware configuration of a printer of the present embodiment.

FIG. 7 is a block diagram illustrating an example of a hardware configuration of a scanner of the present embodiment.

FIG. 8 is a block diagram illustrating an example of functional components of the MFP of the present embodiment.

FIG. 9 is an explanatory diagram illustrating an example of a substitute-device selection screen.

FIG. 10 is a block diagram illustrating an example of functional components of the printer of the present embodiment.

FIG. 11 is a block diagram illustrating an example of functional components of the scanner of the present embodiment.

FIG. 12 is a flowchart illustrating a procedure for a substitution determination process.

FIG. 13 is a flowchart illustrating a procedure for a substitution execution process.

FIG. 14 is a flowchart illustrating a procedure for a storing process.

FIG. 15 is an explanatory diagram illustrating an example of a fee rate table.

FIG. 16 is a block diagram illustrating an example of functional components of a main body section, a server section, a printer, and a scanner of a second modification.

FIG. 17 is a schematic diagram illustrating an example of a billing system of a third modification.

### DESCRIPTION OF EMBODIMENTS

Exemplary embodiments of the present invention are described in detail below with reference to the accompanying drawings.

### Embodiment

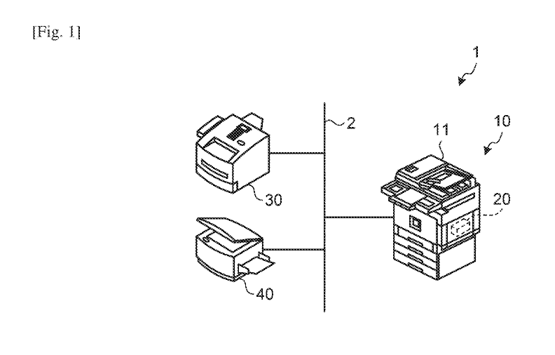

FIG. 1 is a schematic diagram illustrating an example of a billing system 1 of a present embodiment. As illustrated in FIG. 1, the billing system 1 includes an MFP (Multifunction Peripheral) 10, a printer 30, and a scanner 40. The MFP 10, the printer 30, and the scanner 40 are connected via a network 2. Examples of the network 2 include a LAN (Local Area Network) and the Internet. FIG. 1 illustrates an example where the number of MFPs 10, the number of printers 30, and the number of scanners 40 are each one. However, the number is not limited thereto, and can be any number. Another device(s), such as a facsimile and/or a projector, may also be connected.

The MFP 10 is a device, such as an image forming apparatus, having various functions including a copier function, a scanner function, a facsimile function, and a printer function. In the present embodiment, the MFP 10 includes a main body section 11 and a server section 20. The main body section 11 executes the various functions including the copier function, the scanner function, the facsimile function, and the printer function provided by the MFP 10. For instance, the main body section 11 has an OCR (Optical Character Recognition) function for the scanner function. The OCR function is a function of converting character information obtained by scanning an original document into text data.

The server section 20 is a compact, board-like server device. Although it is assumed that the server section 20 is built in the MFP 10 and internally connected to the main body section 11, the configuration is not limited thereto. The server section 20 may be built in the printer 30 or the scanner 40 rather than in the MFP 10.

The printer 30 is a device having the printer function. The scanner 40 is a device having the scanner function. The main body section 11, the printer 30, and the scanner 40 may vary in functions available thereon. For example, it is possible that while the main body section 11 has the OCR function, the scanner 40 does not have the OCR function.

The billing system 1 is a system that, when any one of the plurality of devices including the MFP 10, the printer 30, and the scanner 40 is used, charges for usage on an execution basis. The billing system 1 can propose, when, for example, a function that is to be provided by one device is unavailable due to breakdown or the like, using another device as a substitute. If a user who desires to use a device accepts execution using the other device as the substitute, the device the user initially desires to use notifies the user of information about the device to be used as the substitute, a fee, and the like. The user can execute the function by operating the notified device as the substitute for the device the user initially desires to use with the notified fee. The device executed the function as the substitute sends a notice about the fee and the like for the device executed the function as the substitute to the server section 20. Accordingly, the server section 20 can record the fee for the device executed the function as the substitute. Hereinafter, when a function of a device a user desires to use is unavailable, a device that can provide the function the user desires to use as a substitute for the device the user desired to use is referred to as “substitute device”.

Each of the devices of the billing system 1 may have a parent-child relationship in which a parent device is selected from the plurality of devices. For example, the parent-child relationship may be such that the MFP 10 is the parent device, while the printer 30 and the scanner 40 are the child devices. Also in this case, each of the devices can, irrespective of whether the device is the parent device or the child device, request another device to execute a function as a substitute, and can execute a function as a substitute for another device.

Furthermore, each of the devices can propose any device having a function executable as a substitute. Specifically, the MFP 10 can propose any one of the printer 30 and the scanner 40 as a device that executes a function as a substitute for the MFP 10. The scanner 40 can propose the MFP 10 as a device that executes a function as a substitute for the scanner 40. Furthermore, each of the printer 30 and the scanner 40 can propose the other one of the printer 30 and the scanner 40 if the other one has a function executable as a substitute.

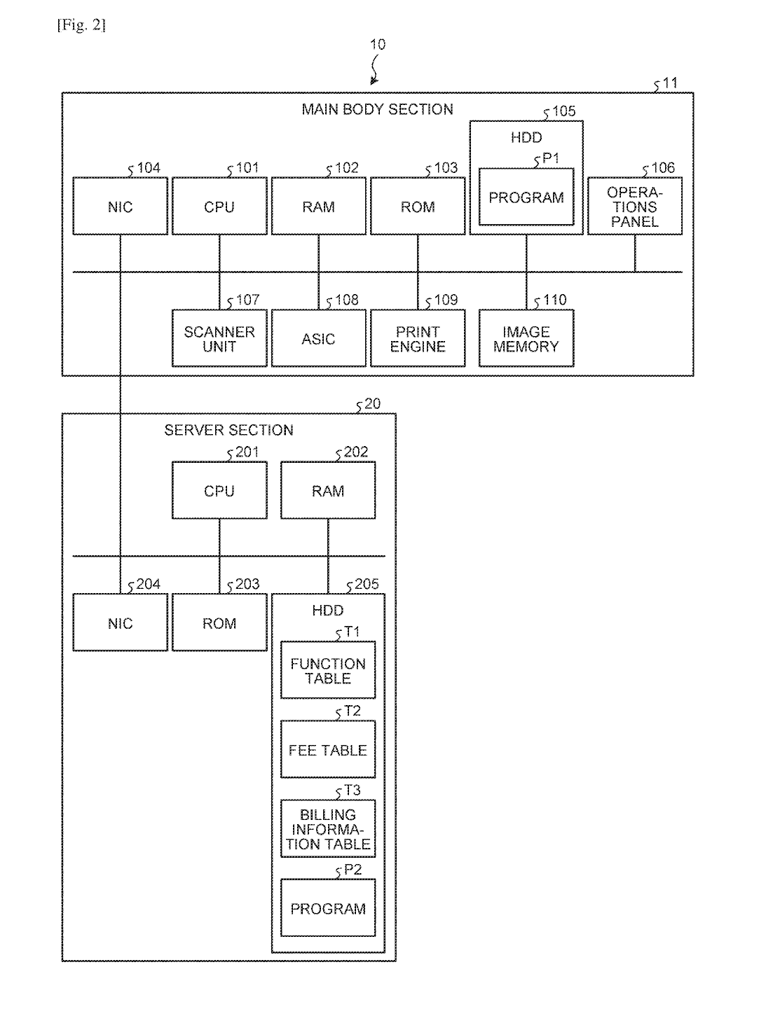

FIG. 2 is a block diagram illustrating an example of a hardware configuration of the MFP 10 of the present embodiment. As illustrated in FIG. 2, the main body section 11 and the server section 20 of the MFP 10 are connected via a bus. The main body section 11 includes a CPU (Central Processing Unit) 101, a RAM (Random Access Memory) 102, a ROM (Read Only Memory) 103, an NIC (Network Interface Controller) 104, an HDD (Hard Disk Drive) 105, an operation panel 106, a scanner unit 107, an ASIC (Application Specific Integrated Circuit) 108, a print engine 109, and an image memory 110. The server section 20 includes a CPU 201, a RAM 202, a ROM 203, a NIC 204, and an HDD 205. The main body section 11 and the server section 20 are connected via a cable or the like. Note that the hardware configuration of the MFP 10 illustrated in FIG. 2 is only an example and is not limited thereto.

The CPU 101 of the main body section 11 performs centralized control of the main body section 11. The RAM 102 is a data-readable-and-writable memory used as a work area for the CPU 101. The ROM 103 is a data-readable memory storing data including program instructions (hereinafter, “programs”) to be executed by the CPU 101. The CPU 101 executes a program P1 stored in the ROM 103 or the HDD 105 on the RAM 102, thereby controlling the NIC 104, the HDD 105, the operation panel 106, the scanner unit 107, the ASIC 108, the print engine 109, the image memory 110, and the like connected via the bus.

The NIC 104 is a communication interface for communications via the network 2. The NIC 104 is a communication interface also used in exchanging notices with the server section 20. The HDD 105 stores various programs and data, and stores image data, on which various image processing is performed by the CPU 101 or the ASIC 108. The HDD 105 also stores the program P1 for performing functions provided by the main body section 11. The program P1 may alternatively be stored in the ROM 103.

The operation panel 106 includes an LCD (Liquid Crystal Display) for displaying a screen, an LED (Light Emitting Diode) for indicating a status, a buzzer, a hard key, and a touch panel. The operation panel 106 displays various information on the LCD and receives various information entered using the hard key or the touch panel.

The scanner unit 107 generates image data by electronically reading in an original document placed on a document table. The ASIC 108 performs various image processing on the read-in image data obtained by the scanner unit 107 and performs various image processing on image data to be printed out by the print engine 109. The print engine 109 prints out the image data. The image memory 110 is a memory for storing the image data having undergone the image processing performed by the ASIC 108 and the image data to be printed out by the print engine 109.

The CPU 201 of the server section 20 performs centralized control of the server section 20. The RAM 202 is a data-readable-and-writable memory used as a work area for the CPU 201. The ROM 203 is a data-readable memory storing data including programs to be executed by the CPU 201. The CPU 201 executes a program P2 stored in the ROM 203 or the HDD 205 on the RAM 202, thereby controlling the NIC 204, the HDD 205, and the like connected via a bus.

The NIC 204 is a communication interface for communications via the network 2. The NIC 204 is a communication interface also used in exchanging notices with the main body section 11. The HDD 205 stores various programs and data. The HDD 205 stores the program P2 for performing functions provided by the server section 20. The program P2 may alternatively be stored in the ROM 203.

Furthermore, the HDD 205 stores a function table T1, a fee table T2, and a billing information table T3.

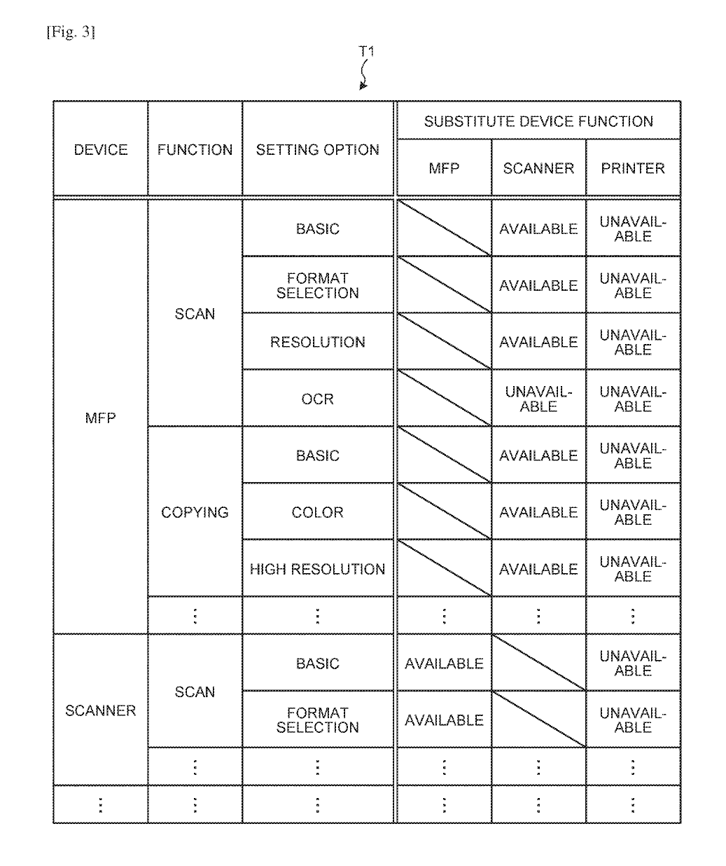

The function table T1 is information storing whether or not, for each of functions of each of the devices included in the billing system 1, the function is available on the other devices. FIG. 3 is an explanatory diagram illustrating an example of the function table T1. The function table T1 stores whether or not each of the other devices in the billing system 1 has a corresponding function(s) and setting option(s). Devices given in the column “DEVICE” are the devices of the billing system 1. Functions given in the column “FUNCTION” are functions available on each of the devices of the billing system 1. Execution conditions for the functions available on each of the devices of the billing system 1 are given in the column “SETTING OPTION”. Specifically, the setting options of, for example, an MFP are execution conditions including basic processing, format selection processing, resolution processing, and OCR processing, for example. The basic is a setting for performing no special processing. The format selection is a setting for selecting a format, in which a scanned original document is to be stored. The format selection function causes a format to be selected from, for example, TIFF (Tagged Image File Format), JPEG (Joint Photographic Experts Group), and PDF (Portable Document Format). The resolution is a setting for selecting a resolution, at which the original document is to be read. The OCR is a setting as to whether or not to perform OCR. Referring to the function table T1 illustrated in FIG. 3, the device “MFP” has “SCAN”, “COPYING”, and other functions as its functions. It is also indicated that the function “SCAN” of the device “MFP” has “BASIC”, “FORMAT SELECTION”, “RESOLUTION”, “OCR”, and other functions as its setting options.

Whether or not each of the devices has functions corresponding to the functions associated in the function table T1 is indicated in the column “SUBSTITUTE DEVICE FUNCTION”. Referring to the function table T1 illustrated in FIG. 3, while the device “SCANNER” has a function corresponding to the setting option “BASIC” of the function “SCAN” available on the device “MFP”, the device “PRINTER” does not have the corresponding function. It is also indicated that neither the device “SCANNER” nor the device “PRINTER” has a setting option corresponding to the setting option “OCR” of the function “SCAN” available on the device “MFP”.

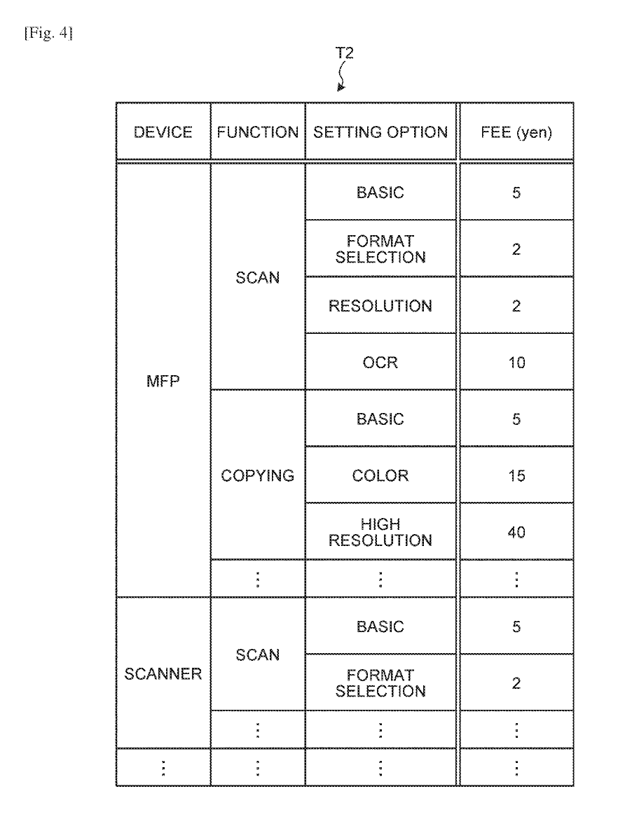

The fee table T2 is information where fees for usage of each of the functions of each of the devices included in the billing system 1 are stored on a setting-option-by-setting-option basis. FIG. 4 is an explanatory diagram illustrating an example of the fee table T2. The fee table T2 stores fees for the functions of the devices on the setting-option-by-setting-option basis. The devices, functions, and the setting options of the fee table T2 are the same as the devices, functions, and setting options of the function table T1. Fees per unit amount are given on the setting-option-by-setting-option basis in the column “FEE”. Referring to the function “SCAN” available on the device “MFP” in the fee table T2 illustrated in FIG. 4, the fee for the setting option “BASIC” is “5” yen, and the fee for the setting option “FORMAT SELECTION” is “2” yen. The fee is an amount of money charged per sheet for scan of an original document.

The billing information table T3 stores billing information. The billing information is information about fees, for each of the functions of the devices included in the billing system 1, charged for usage of the function. FIG. 5 is an explanatory diagram illustrating an example of the billing information table T3. The billing information table T3 stores item numbers and the billing information. The item numbers are identification information, by which each billing information piece stored in the billing information table T3 is identifiable. The billing information stores dates and times of use, devices, users, functions, setting options, execution amounts, and total billed amounts. Dates and times when each of the functions of each of the devices included in the billing system 1 is executed are given in the column “DATE AND TIME OF USE”. Devices involved in execution of the functions are given in the column “DEVICE”. Identification information, by which users of the devices are identifiable, is given in the column “USER”. Executed functions are given in the column “FUNCTION”. Setting options applied to the executed functions are given in the column “SETTING ITEM”. Executed amounts each expressed as the numbers of unit amounts are given in the column “EXECUTED AMOUNT”. Totals of fees charged for execution of the functions are given in the column “TOTAL BILLED AMOUNT”.

Referring to the billing information piece of the item number “1” in the billing information table T3 illustrated in FIG. 5, at date and time of use “2015/6/18 15:25:10”, a user “USER A” executed the function “SCAN” the executed amount “10” using the device “MFP” with the setting options “BASIC” and “OCR”, and a total billed amount therefor is “50” yen. Referring to the billing information piece of the item number “2”, at date and time of use “2015/6/18 15:37:45”, the user “USER A” executed the function “SCAN” the executed amount “10” using the device “SCANNER” with the setting option “BASIC”, and a total billed amount therefor is “50” yen.

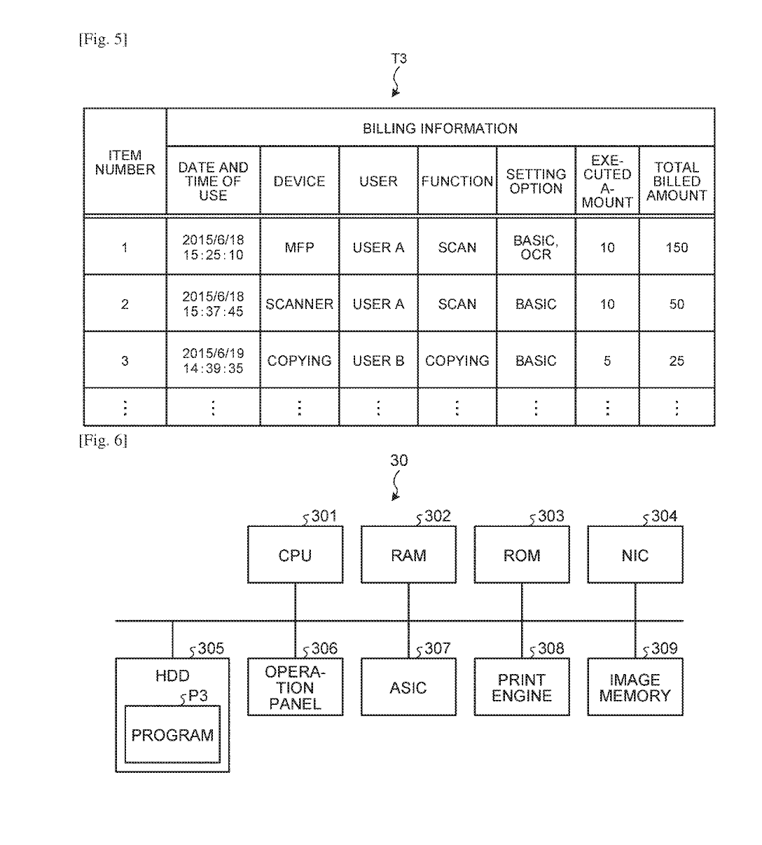

FIG. 6 is a block diagram illustrating an example of a hardware configuration of the printer 30 of the present embodiment. As illustrated in FIG. 6, the printer 30 includes a CPU 301, a RAM 302, a ROM 303, a NIC 304, an HDD 305, an operation panel 306, an ASIC 307, a print engine 308, and an image memory 309. Note that the hardware configuration of the printer 30 illustrated in FIG. 6 is only an example and is not limited thereto.

The CPU 301 performs centralized control of the printer 30. The RAM 302 is a data-readable-and-writable memory used as a work area for the CPU 301. The ROM 303 is a data-readable memory storing data including programs to be executed by the CPU 301. The CPU 301 executes a program P3 stored in the ROM 303 or the HDD 305 on the RAM 302, thereby controlling the NIC 304, the HDD 305, the operation panel 306, the ASIC 307, the print engine 308, the image memory 309, and the like connected via a bus.

The NIC 304 is a communication interface for communications via the network 2. The HDD 305 stores various programs and data, and stores image data, on which various image processing is performed by the CPU 301 or the ASIC 307. The HDD 305 stores the program P3 for performing functions provided by the printer 30. The program P3 may alternatively be stored in the ROM 303.

The ASIC 307 performs various image processing on image data to be printed out by the print engine 308. The operation panel 306 includes an LCD for displaying a screen, an LED for indicating a status, a buzzer, a hard key, and a touch panel. The operation panel 306 displays various information on the LCD and receives various information entered using the hard key or the touch panel.

The ASIC 307 performs various image processing on image data to be printed out by the print engine 308. The print engine 308 prints out the image data. The image memory 309 is a memory for storing the image data to be printed out by the print engine 308.

FIG. 7 is a block diagram illustrating an example of a hardware configuration of the scanner 40 of the present embodiment. As illustrated in FIG. 7, the scanner 40 includes a CPU 401, a RAM 402, a ROM 403, a NIC 404, an HDD 405, an operation panel 406, a scanner unit 407, an ASIC 408, and an image memory 409. Note that the hardware configuration of the scanner 40 illustrated in FIG. 7 is only an example and is not limited thereto.

The CPU 401 performs centralized control of the scanner 40. The RAM 402 is a data-readable-and-writable memory used as a work area for the CPU 401. The ROM 403 is a data-readable memory storing data including programs to be executed by the CPU 401. The CPU 401 executes a program P4 stored in the ROM 403 or the HDD 405 on the RAM 402, thereby controlling the NIC 404, the HDD 405, the operation panel 406, the scanner unit 407, the ASIC 408, the image memory 409, and the like connected via a bus.

The NIC 404 is a communication interface for communications via the network 2. The HDD 405 stores various programs and data, and stores image data, on which various image processing is performed by the CPU 401 or the ASIC 408. The HDD 405 stores the program P4 for performing functions provided by the scanner 40. The program P4 may alternatively be stored in the ROM 403.

The operation panel 406 includes an LCD for displaying a screen, an LED for indicating a status, a buzzer, a hard key, and a touch panel. The operation panel 406 displays various information on the LCD and receives various information entered using the hard key or the touch panel.

The scanner unit 407 generates image data by electronically reading in an original document placed on a document table. The ASIC 408 performs various image processing on the read-in image data obtained by the scanner unit 407. The image memory 409 is a memory for storing the image data having undergone the image processing performed by the ASIC 408.

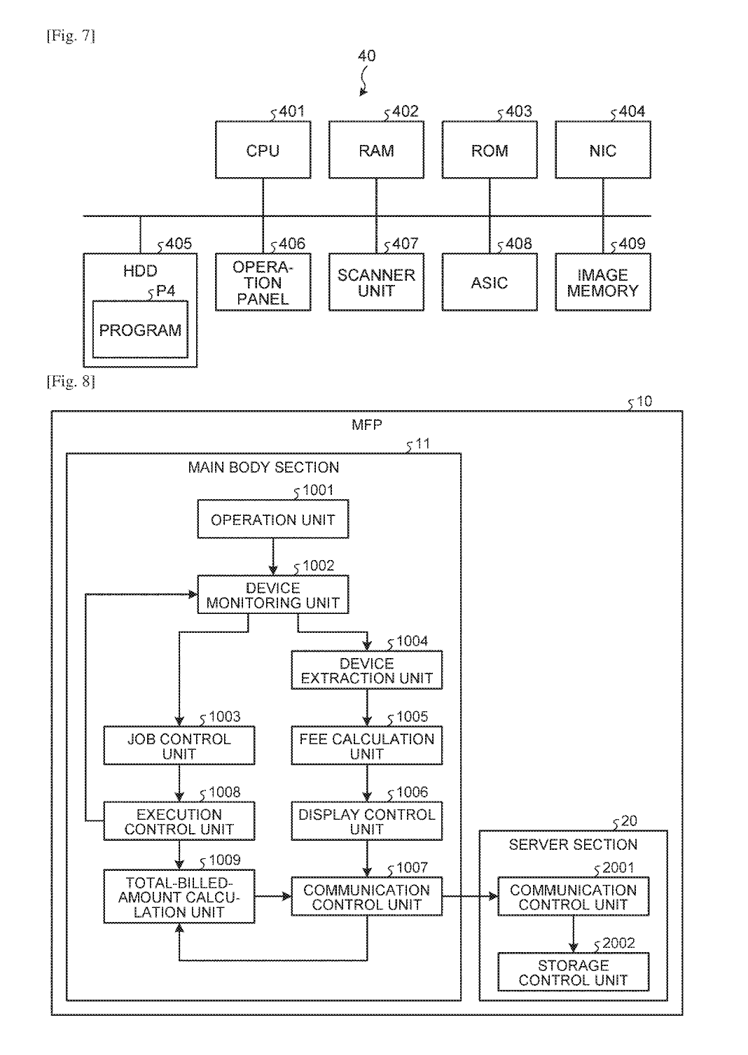

Functional components included in the MFP 10 are described below. FIG. 8 is a block diagram illustrating an example of the functional components of the MFP 10 of the present embodiment.

Functional components of the main body section 11 are described first. The CPU 101 of the main body section 11 loads the program P1 into the RAM 102 from the HDD 105 and operates in accordance with the program P1, thereby generating the functional parts illustrated in FIG. 8 on the RAM 102. Specifically, the CPU 101 of the main body section 11 includes, as its functional units, an operation unit 1001, a device monitoring unit 1002, a job control unit 1003, a device extraction unit 1004, a fee calculation unit 1005, a display control unit 1006, a communication control unit 1007, an execution control unit 1008, and a total-billed-amount calculation unit 1009. Note that the functional components included in the main body section 11 are not limited thereto.

The operation unit 1001 receives various operations performed by a user on the operation panel 106. The operation unit 1001, which is an example of operation unit, receives, for example, an operation for executing a certain function, such as the copier function, the scanner function, the facsimile function, or the printer function, provided by the MFP 10. Furthermore, the operation unit 1001 receives an operation designating a setting option(s), which is an execution condition(s) for the certain function.

Furthermore, the operation unit 1001 receives user information entered using a numeric key on the touch panel of the operation panel 106 or the like. The user information is identification information, by which a user is identifiable. The operation unit 1001 may receive user information not only from the operation panel 106 but also by reading out user information from a storage medium, such as an IC (Integrated Circuit) card or a USB (Universal Serial Bus) memory, when the storage medium is connected.

The device monitoring unit 1002 monitors whether or not the MFP 10 is in a state where the execution control unit 1008 can execute the functions provided by the MFP 10. The device monitoring unit 1002, which is an example of determination part, compares the function and the setting options associated with the operation received by the operation unit 1001 against result of the monitoring performed on the MFP 10, thereby determining whether or not the MFP 10 is in a state where the operated function and setting options are executable. For instance, if the MFP 10 has a troubled portion, the device monitoring unit 1002 determines that a function that uses the troubled portion is inexecutable. On the other hand, if no troubled portion or the like is detected, the device monitoring unit 1002 determines that the function and the setting options associated with the operation received by the operation unit 1001 are executable.

If a large number of jobs are already submitted to the execution control unit 1008, a user cannot use the device immediately due to a queue of jobs waiting to be run. For this reason, the device monitoring unit 1002 monitors the number of jobs submitted to the execution control unit 1008. If the device monitoring unit 1002 determines that the number of jobs submitted to the execution control unit 1008 is smaller than a threshold value, the device monitoring unit 1002 determines that the function and the setting options associated with the operation received by the operation unit 1001 are executable. On the other hand, if the device monitoring unit 1002 determines that the number of jobs submitted to the execution control unit 1008 is larger than the threshold value, the device monitoring unit 1002 determines that the function and the setting options associated with the operation received by the operation unit 1001 are inexecutable.

If the device monitoring unit 1002 determines that the function and the setting options associated with the operation received by the operation unit 1001 are executable, the job control unit 1003 generates a job for executing the function associated with the operation. Specifically, the job control unit 1003 generates a job for executing a certain function, such as the copier function, the scanner function, the facsimile function, or the printer function, provided by the MFP 10. The job control unit 1003 requests the execution control unit 1008 to execute the generated job.

If the device monitoring unit 1002 determines that the function is inexecutable, the device extraction unit 1004, which is an example of extraction unit, extracts one or more substitute devices capable of executing the function associated with the operation received by the operation unit 1001 as a substitute for the MFP 10 from the function table T1. At this time, the device extraction unit 1004 identifies a setting option(s) executable by the extracted device(s). Specifically, the device extraction unit 1004 extracts a device(s), to which the function and the setting option(s) associated with the operation received by the operation unit 1001 are applicable from the function table T1. At this time, if there is no device, to which all the setting options of the function are applicable, the device extraction unit 1004 extracts a device capable of executing the function, while neglecting whether or not all the setting options are applicable to the device, from the function table T1 as a substitute device. The device extraction unit 1004 identifies that a same setting option as the setting option registered in the function table T1 is applicable to the extracted device. Thus, even if the main body section 11 cannot provide a function a user desires to use, the device extraction unit 1004 can notify the user of a device capable of executing the function as a substitute.

The fee calculation unit 1005, which is an example of first calculation unit, calculates a fee per unit amount of execution of the function by the substitute device extracted by the device extraction unit 1004 as a substitute for the MFP 10. The fee calculation unit 1005 determines whether or not the substitute device(s) extracted by the device extraction unit 1004 is a device(s) capable of executing all the function and setting options associated with the operation received by the operation unit 1001. If the substitute device(s) extracted by the device extraction unit 1004 is a device(s) capable of executing all the setting options of the function associated with the operation received by the operation unit 1001, the fee calculation unit 1005 calculates a not-adjusted, normal fee in accordance with the fee table T2. On the other hand, if the substitute device(s) extracted by the device extraction unit 1004 can execute none or only some of the setting options of the function associated with the operation received by the operation unit 1001, the fee calculation unit 1005 calculates a fee to a value lower than the fee for execution of the function, to which all the setting options are applied.

Specifically, the fee calculation unit 1005 calculates a fee for execution of the function by the substitute device incapable of executing some of the setting options in two stages. In the first stage of the fee calculation, the fee calculation unit 1005 calculates a fee for execution of the function by the substitute device. In the second stage of the fee calculation, the fee calculation unit 1005 adjusts the fee calculated in the first stage for the substitution by the substitute device.

The fee calculation unit 1005 can calculate the fee in the first stage by various calculation methods. For instance, the fee calculation unit 1005 may calculate the fee in the first stage by subtracting a fee for a setting option(s) inapplicable to the substitute device from a fee for execution of the setting options of the function the user initially desires to use.

This will be described through an example below. For example, the following situation is assumed. A user desires to execute scan with OCR on the MFP 10. However, scan of the MFP 10 is unavailable due to a breakdown or the like. Under this circumstance, the scanner 40 executes scan as a substitute device. The fee for execution of scan with OCR on the MFP 10 is “15” yen, which is calculated by adding a fee for “BASIC” and a fee for “OCR” given in the fee table T2 illustrated in FIG. 4. However, the scanner 40, which is the substitute device, cannot execute “OCR”. Accordingly, the fee in the first stage is 5 yen, which is calculated by subtracting the fee for “OCR” from the fee for “BASIC” and “OCR”.

The fee calculation unit 1005 can calculate the fee in the second stage by various calculation methods. For instance, the fee calculation unit 1005 can calculate the fee in the second stage by reducing the fee in the first stage by a certain amount of money (hereinafter, “amount”) or by a certain ratio. Specifically, the fee calculation unit 1005 calculates the fee in the second stage by reducing the fee in the first stage by several yen or by several percent.

Alternatively, the fee calculation unit 1005 may calculate the fee in the second stage by subtracting a fee that is to be charged when the user executes the function again by using the device the user initially desires to use after the device the user initially desires to use has recovered. Further alternatively, the fee calculation unit 1005 may calculate the fee in the second stage by subtracting a fee that is to be charged when the user uses a device of a system other than the billing system 1. By subtracting the fee in this manner, the fee calculation unit 1005 can make the user more likely to receive using the substitute device.

The amount or rate by which the fee calculation unit 1005 reduces the fee is not necessarily fixed but may vary. For instance, the fee calculation unit 1005 may calculate the fee depending on the number of setting options of the function of the substitute device by referring to the function table T1. Specifically, the fee calculation unit 1005 compares the number of the setting options of the function of the substitute device against the number of setting options of the function of the device the user desires to use by referring to the function table T1, thereby determining whether or not the substitute device has higher functionality. The fee calculation unit 1005 may determine the amount or rate depending on the difference between the numbers of the setting options. For instance, the fee calculation unit 1005 may reduce the fee by 1 yen or by 10 percent for each setting option, by which the number of setting options of the function of the substitute device is smaller. In the calculation of the fee in the second stage, the fee calculation unit 1005 may increase the fee rather than only decreasing the fee. For instance, the fee calculation unit 1005 may increase the fee when the number of the setting options of the function of the substitute device is larger than the number of setting options of the function of the device the user desires to use by referring to the function table T1. The fee calculation unit 1005 may increase the fee by 1 yen or by 10 percent for each setting option, by which the number of setting options of the function of the substitute device is larger.

The display control unit 1006 controls the operation panel 106 and the image memory 110, thereby causing various information to be displayed on the operation panel 106. For instance, the display control unit 1006, which is an example of display control unit, causes a substitute-device selection screen to be displayed on the operation panel 106. FIG. 9 is an explanatory diagram illustrating an example of a substitute-device selection screen G1. The substitute-device selection screen G1, which is an example of selection screen, is a screen from which, when a device a user desires to use is unavailable, one substitute device to be put into actual use is to be selected from one or more substitute devices extracted by the device extraction unit 1004. The substitute-device selection screen G1 contains a message G11, a substitute device list G12, substitute-device selection buttons G13a and G13b, and a substitution cancel button G14. The display control unit 1006 displays “This MFP is out of order and unusable. Do you want to use a substitute device?” on the message G11. If the device monitoring unit 1002 determines that the MFP 10 is unavailable because a large number of jobs are submitted, the display control unit 1006 displays “This MFP is unusable because a large number of jobs are submitted. Do you want to use a substitute device?”. The display control unit 1006 urges the user to use a substitute device in this manner.

The substitute device list G12 displays a list of substitute devices. In the substitute device list G12, substitute devices, functionality levels, available setting options, unavailable setting options, and fees are displayed. Substitute devices extracted by the device extraction unit 1004 are given in the column “SUBSTITUTE DEVICE”. For each of the substitute devices, whether or not a larger number of setting options are applicable to the substitute device than to the device the user desires to use is given in the column “FUNCTIONALITY LEVEL”. The functionality level is a result of determination made by the fee calculation unit 1005 by comparing the numbers of setting options given in the function table T1. A function the substitute device can execute is given in the column “FUNCTION”. Setting option(s) applicable to the function of the substitute device is given in the column “AVAILABLE SETTING OPTION”. Setting option(s) inapplicable to the function of the substitute device is given in the column “UNAVAILABLE SETTING OPTION”. A fee per unit amount for execution by the substitute device calculated by the fee calculation unit 1005 is given in the column “FEE”.

FIG. 9 illustrates the substitute device list G12 in an example where a scanner A and a scanner B are extracted as substitute devices by the device extraction unit 1004. Each of the substitute-device selection buttons G13 is a button to be clicked to select a scanner as the substitute device. If the substitute-device selection button G13a is clicked, the display control unit 1006 causes the operation panel 106 to display a message presenting a fee for the substitute device as follows: “Perform substitutional scanning using the scanner. Because OCR processing is not executed, fee per sheet of original document is 7 yen”. If the substitute-device selection button G13b is clicked, the display control unit 1006 causes the operation panel 106 to display a message presenting a fee for the substitute device as follows: “Perform substitutional scanning using the scanner B. Because OCR processing is not executed, fee per sheet of original document is 8 yen”. The substitution cancel button G14 is a button to be clicked to cancel execution using a substitute device. If the substitution cancel button G14 is clicked, the display control unit 1006 causes the operation panel 106 to display a message “Scanning is unavailable until the MFP 10 becomes usable.” to indicate that execution is unavailable.

The communication control unit 1007 controls the NIC 104, thereby controlling communications carried out via the network 2. More specifically, the communication control unit 1007 reads out information representing the function table T1 and the fee table T2 stored in the HDD 205 of the server section 20. Furthermore, the communication control unit 1007 controls transmission and reception of substitution information and billing information. The substitution information is information requesting a substitute device selected by a user to execute a function as a substitute. More specifically, the substitution information contains user information, the function and setting options to be executed as the substitute, and a fee calculated by the fee calculation unit 1005. The communication control unit 1007 transmits the substitution information to the substitute device selected by the user from the substitute-device selection screen G1. Hence, the substitute device that receives the substitution information can charge the fee contained in the substitution information when the user indicated by the user information causes the substitute device to execute the function with the setting options as the substitute.

Furthermore, the communication control unit 1007 receives the substitution information when the MFP 10 is to serve as the substitute device. The communication control unit 1007 transmits billing information to the server section 20. Hence, the server section 20 can record the billing information.

The execution control unit 1008 executes a job generated by the job control unit 1003. Specifically, the execution control unit 1008 executes a certain function, such as the copier function, the scanner function, the facsimile function, or the printer function, provided by the MFP 10. More specifically, if the device monitoring unit 1002 determines that the job, which is associated with the operation, generated by the job control unit 1003 is executable, executes the function involved in the job. At this time, if a setting option(s) is applied to the function involved in the job, the execution control unit 1008 can execute the function in accordance with a setting condition(s) set to the setting option(s).

The total-billed-amount calculation unit 1009 calculates a total billed amount of a function actually executed by the execution control unit 1008. Specifically, when a job is executed by the execution control unit 1008, the total-billed-amount calculation unit 1009 determines whether or not the job is executed as a substitute device. The total-billed-amount calculation unit 1009 determines that the job is executed as a substitute device if the user information and the function contained in the substitution information match a user and a function of the job executed by the execution control unit 1008. In this example, the total-billed-amount calculation unit 1009, which is an example of second calculation unit, calculates the total billed amount based on the fee contained in the substitution information and data about execution by the execution control unit 1008. Specifically, the total-billed-amount calculation unit 1009 calculates the total billed amount by multiplying the fee contained in the substitution information by the number of unit amounts executed by the execution control unit 1008. Even if the user information and the function contained in the substitution information match the user and the function of the job executed by the execution control unit 1008, when another job is already executed based on the substitution information, the total-billed-amount calculation unit 1009 determines that the job is not a job executed as a substitute device. When the job is determined as not being a job executed as a substitute device, the total-billed-amount calculation unit 1009 calculates a normal total billed amount by multiplying the fee given in the fee table T2 by the number of unit amounts executed by the execution control unit 1008.

Functional components of the server section 20 are described below. The CPU 201 of the server section 20 loads the program P2 into the RAM 202 from the HDD 205 and operates in accordance with the program P2, thereby generating the functional parts illustrated in FIG. 8 on the RAM 202. Specifically, the CPU 201 of the server section 20 includes a communication control unit 2001 and a storage control unit 2002 as its functional parts. Note that the functional components included in the server section 20 are not limited thereto.

The communication control unit 2001 controls the NIC 204, thereby controlling communications carried out via the network 2. Specifically, the communication control unit 2001 transmits the information representing the function table T1 and the fee table T2. The communication control unit 2001 also receives billing information.

The storage control unit 2002 causes the billing information received by the communication control unit 2001 to be stored in the billing information table T3. Thereafter, a provider of the billing system 1 demands payment of a bill based on the billing information stored in the billing information table T3.

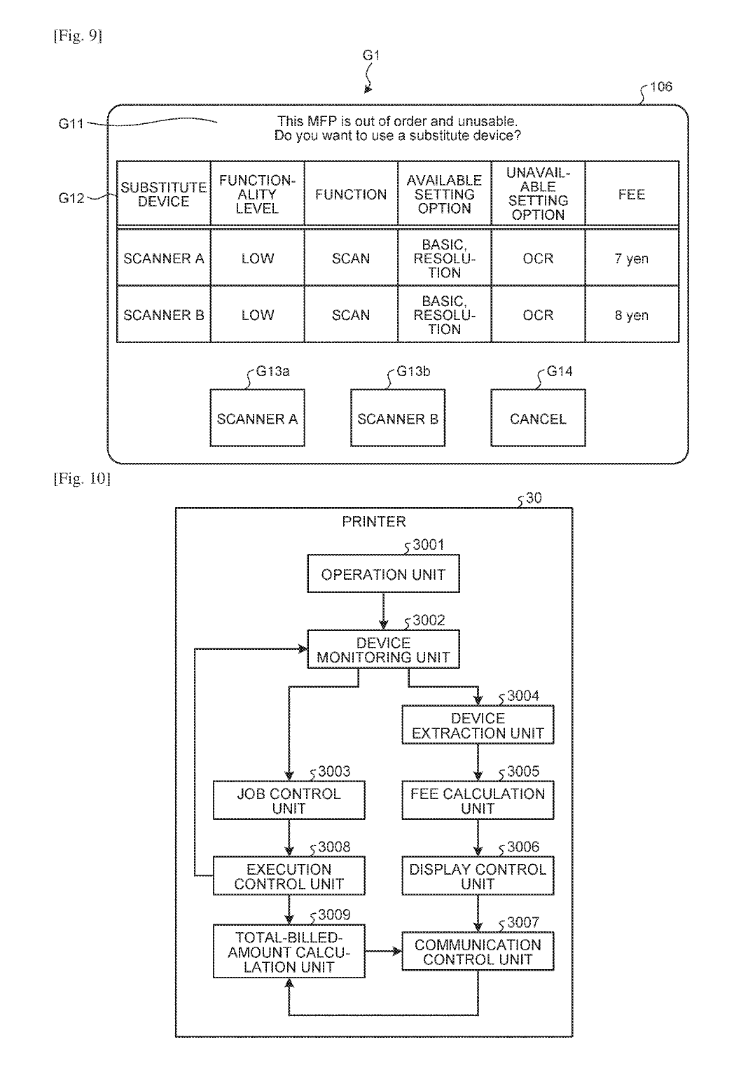

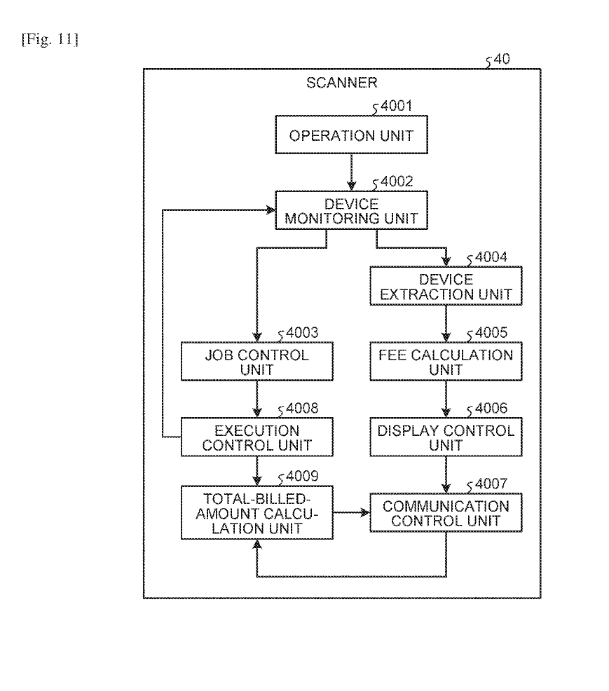

Functional components of the printer 30 are described below. FIG. 10 is a block diagram illustrating an example of the functional components of the printer 30 of the present embodiment.

The CPU 301 of the printer 30 loads the program P3 into the RAM 302 from the HDD 305 and operates in accordance with the program P3, thereby generating the functional parts illustrated in FIG. 10 on the RAM 302. Specifically, the CPU 301 of the printer 30 includes, as its functional parts, an operation unit 3001, a device monitoring unit 3002, a job control unit 3003, a device extraction unit 3004, a fee calculation unit 3005, a display control unit 3006, a communication control unit 3007, an execution control unit 3008, and a total-billed-amount calculation unit 3009.

Each of the above-described functions of the printer 30 is functionally equivalent to a corresponding one of the operation unit 1001, the device monitoring unit 1002, the job control unit 1003, the device extraction unit 1004, the fee calculation unit 1005, the display control unit 1006, the communication control unit 1007, the execution control unit 1008, and the total-billed-amount calculation unit 1009 included in the main body section 11. Note that the functional components included in the printer 30 are not limited thereto.

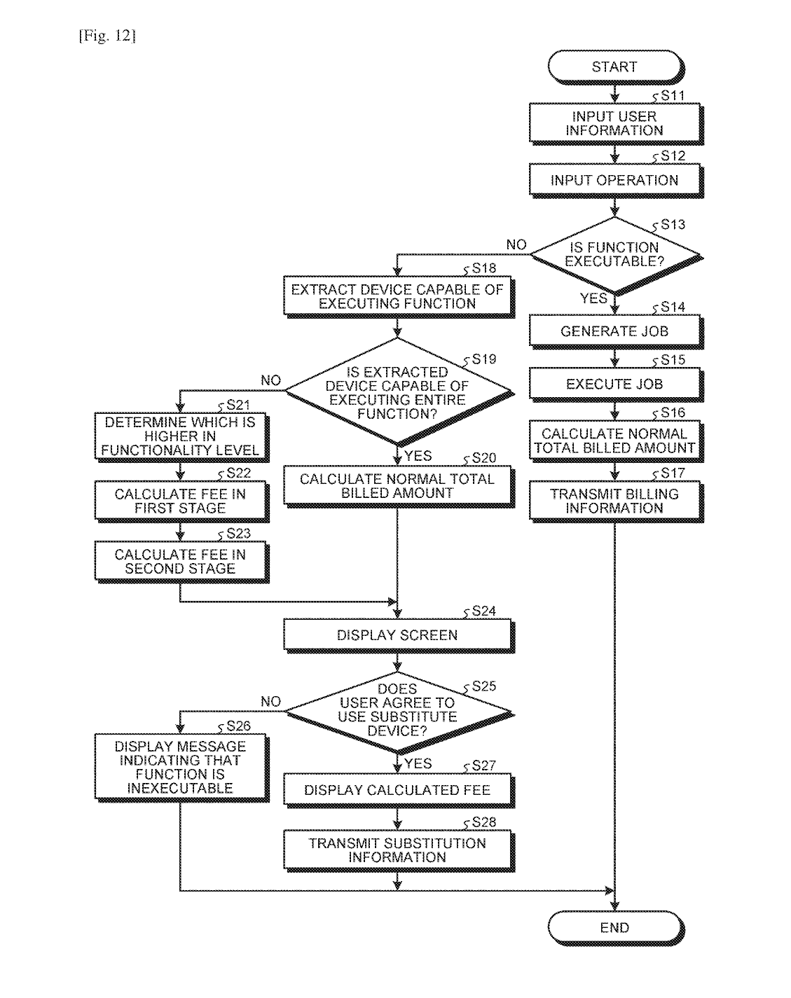

Functional components of the scanner 40 are described below. FIG. 11 is a block diagram illustrating an example of the functional components of the scanner 40 of the present embodiment.

The CPU 401 of the scanner 40 loads the program P4 into the RAM 402 from the HDD 405 and operates in accordance with the program P4, thereby generating the functional units illustrated in FIG. 11 on the RAM 402. Specifically, the CPU 401 of the scanner 40 includes, as its functional parts, an operation unit 4001, a device monitoring unit 4002, a job control unit 4003, a device extraction unit 4004, a fee calculation unit 4005, a display control unit 4006, a communication control unit 4007, an execution control unit 4008, and a total-billed-amount calculation unit 4009.

Each of the above-described functions of the scanner 40 is functionally equivalent to a corresponding one of the operation unit 1001, the device monitoring unit 1002, the job control unit 1003, the device extraction unit 1004, the fee calculation unit 1005, the display control unit 1006, the communication control unit 1007, the execution control unit 1008, and the total-billed-amount calculation unit 1009 included in the main body section 11. Note that the functional components included in the scanner 40 are not limited thereto.

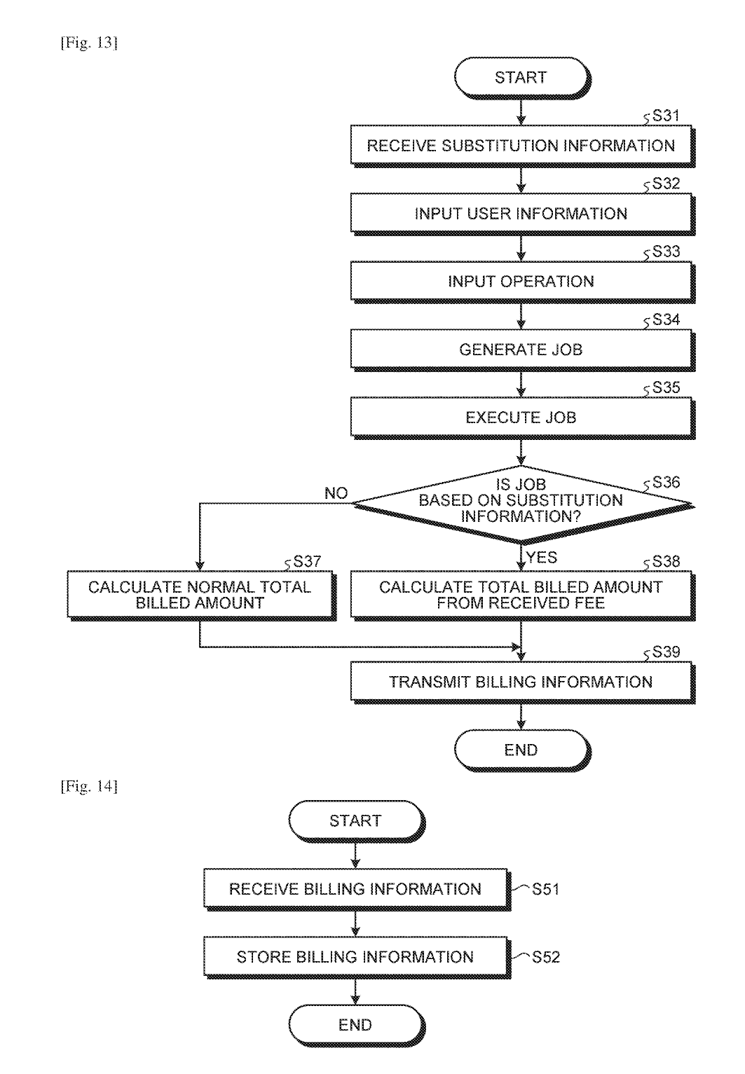

A substitution determination process to be performed by each of the devices of the billing system 1 of the present embodiment is described below. The substitution determination process is a process of determining whether or not a function of a device desired by a user is available and, if the function is unavailable, proposing the user to use a substitute device. FIG. 12 is a flowchart illustrating a procedure for the substitution determination process to be executed by the MFP 10 of the billing system 1 of the present embodiment. FIG. 12 illustrates an example of the substitution determination process in a situation where a device a user desires to use is the MFP 10.

The operation unit 1001 of the main body section 11 receives an input of user information about the user using the MFP 10 (Step S11). Thereafter, the operation unit 1001 of the main body section 11 inputs a function provided by the MFP 10, setting options of the function, and an execution amount (Step S12).

Thereafter, the device monitoring unit 1002 of the main body section 11 determines whether or not the operated function is executable (Step S13).

If the operated function is executable (Yes at Step S13), the job control unit 1003 of the main body section 11 generates a job involving the input function and setting options (Step S14).

Thereafter, the execution control unit 1008 of the main body section 11 executes the generated job (Step S15). Thereafter, the fee calculation unit 1005 of the main body section 11 calculates a total billed amount, which depends on the function, the setting options, and the execution amount, from a normal fee (Step S16). Thereafter, the communication control unit 1007 of the main body section 11 transmits billing information containing the calculated total billed amount to the server section 20 (Step S17).

On the other hand, if the operated function is not executable (No at Step S13), the device extraction unit 1004 of the main body section 11 extracts a device(s) capable of executing the job from the function table T1 (Step S18). Specifically, the device extraction unit 1004 of the main body section 11 extracts the scanner 40 capable of executing the scan function from the function table T1.

Thereafter, the fee calculation unit 1005 of the main body section 11 determines whether or not the extracted substitute device is capable of executing all the function and setting options associated with the operation received by the operation unit 1001 (Step S19).

If the extracted substitute device is capable of executing all the function and setting options associated with the operation received by the operation unit 1001 (Yes at Step S19), the fee calculation unit 1005 of the main body section 11 calculates a normal fee in accordance with the fee table T2 (Step S20).

On the other hand, if the extracted substitute device is not capable of executing some of the setting options of the function associated with the operation received by the operation unit 1001 (No at Step S19), the fee calculation unit 1005 of the main body section 11 determines which is higher in functionality level, the function that may be executed by the main body section 11 or the function that may be executed by the scanner 40 as a substitute (Step S21).

Thereafter, the fee calculation unit 1005 of the main body section 11 calculate a fee in the first stage (Step S22).

Thereafter, the fee calculation unit 1005 of the main body section 11 calculates a fee in the second stage by adjusting the fee in the first stage (Step S23).

Thereafter, the display control unit 1006 causes the substitute-device selection screen G1 to be displayed on the operation panel 106 (Step S24).

Thereafter, the operation unit 1001 of the main body section 11 determines whether or not an operation, entered by the user, of selecting a substitute device to agree to execution of the function using the substitute device is accepted (Step S25). If an operation of canceling execution using a substitute device entered by the user not agreeing to use a substitute device is accepted (No at Step S25), the operation unit 1001 of the main body section 11 provides a notification to the user by causing the operation panel 106 to display a message indicating that the function is inexecutable (Step S26).

On the other hand, if the operation of selecting a substitute device is accepted (Yes at Step S25), the communication control unit 1007 of the main body section 11 provides a notification to the user by causing the operation panel 106 to display a message presenting the fee for the substitute device (Step S27).

Thereafter, the communication control unit 1007 of the main body section 11 transmits substitution information containing the device selected from the substitute-device selection screen G1 and the fee calculated in a fee calculation process (Step S28).

The substitution determination process performed by the MFP 10 then ends.

A substitution execution process to be performed by each of the devices of the billing system 1 of the present embodiment is described below. The substitution execution process is a process of, when a function of a device desired by a user is unavailable, executing the function using a substitute device. FIG. 13 is a flowchart illustrating a procedure for the substitution execution process to be executed by the MFP 10 of the billing system 1 of the present embodiment. FIG. 13 illustrates an example of the substitution execution process in a situation where the substitute device is the scanner 40.

The communication control unit 4007 of the scanner 40 receives the substitution information transmitted from the MFP 10 (Step S31).

Thereafter, the operation unit 4001 of the scanner 40 receives an input of user information about the user using the MFP 10 (Step S32). Thereafter, the operation unit 4001 of the scanner 40 inputs a function) provided by the MFP 10, setting options of the function, and an execution amount (Step S33).

Thereafter, the job control unit 4003 of the scanner 40 generates a job for the operated function (Step S34). Thereafter, the execution control unit 4008 of the scanner 40 executes the generated job (Step S35).

Thereafter, the total-billed-amount calculation unit 4009 of the scanner 40 determines whether or not the executed job is a job based on substitution information (Step S36). If the executed job is not a job based on substitution information (Not at Step S36), the fee calculation unit 1005 of the main body section 11 calculates a total billed amount, which depends on the function, the setting options, and the execution amount, from a normal fee (Step S37).

On the other hand, if the executed job is a job based on substitution information (Yes at Step S36), the total-billed-amount calculation unit 4009 of the scanner 40 calculates a total billed amount by multiplying the number of unit amounts executed by the execution control unit 4008 by the fee contained in the substitution information (Step S38).

Thereafter, the communication control unit 4007 of the scanner 40 transmits billing information containing the calculated total billed amount to the server section 20 (Step S39).

The substitution execution process performed by the scanner 40 then ends.

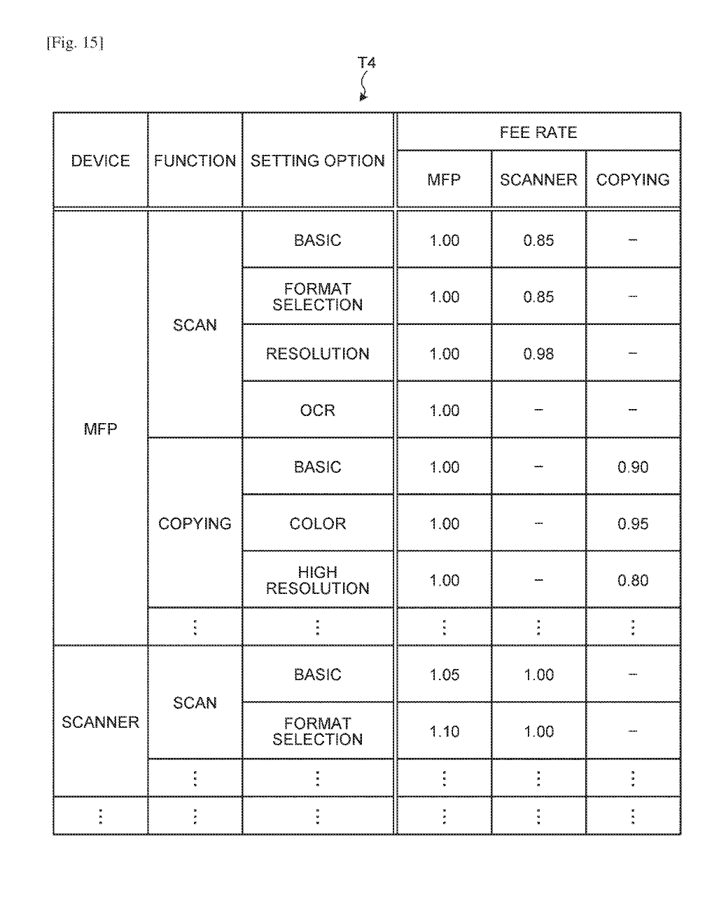

A storing process to be performed by the server section 20 of the billing system 1 of the present embodiment is described below. The storing process is a process of storing the received billing information in the billing information table T3. FIG. 14 is a flowchart illustrating a procedure for the storing process to be executed by the MFP 10 of the billing system 1 of the present embodiment.

The communication control unit 2001 of the server section 20 receives the transmitted billing information (Step S51).

Thereafter, the storage control unit 2002 of the server section 20 causes the received billing information to be stored in the billing information table T3 (Step S52).

The storing process performed by the server section 20 then ends.

As described above, according to the billing system 1 of the present embodiment, when an operated function is unavailable due to a breakdown or the like, the device extraction unit 1004 of the main body section 11 of the MFP 10 extracts a substitute device(s) having the same function as the operated function by referring to the function table T1. The fee calculation unit 1005 calculates, for each of the extracted substitute device(s), a fee for execution of the function as a substitute for the MFP 10. The display control unit 1006 causes the extracted substitute device(s), a fee(s) for execution of the function by the substitute device(s), and the like to be displayed on the substitute-device selection screen G1. The communication control unit 1007 transmits substitution information to a selected one of the substitute device(s). Upon receiving the substitution information, the scanner 40 calculates a total billed amount from the fee contained in the substitution information when a function executed by the scanner 40 is a function executed as a substitute for the MFP 10. The scanner 40 causes the calculated total billed amount to be stored in the billing information table T3. A provider of the billing system 1 demands payment of a bill based on the total billed amount stored in the billing information table T3. Accordingly, even if a user cannot use a function of a desired device, the user can use a function of another device as a substitute with a fee calculated for the substitution. Accordingly, the billing system 1 of the present embodiment can maintain a user's satisfaction level even in a situation where a function of a device the user desires to use is unavailable.

A first modification of the billing system 1 is described below.

Each of the fee calculation unit 1005 of the main body section 11, the fee calculation unit 3005 of the printer 30, and the fee calculation unit 4005 of the scanner 40 calculates a fee in the first stage based on a fee rate specified in a fee rate table.

FIG. 15 is an explanatory diagram illustrating an example of a fee rate table T4. The fee rate table T4 is information indicating fee rates for each of the functions of the devices included in the billing system 1. The fee rate table T4 stores devices, functions, setting options, and fee rates. The devices, functions, and setting options of the fee rate table T4 are the same as the devices, functions, and setting options of the function table T1. The fee rate is information indicating, for each of the devices, a rate of fee with respect to a fee specified in the fee table T2. For instance, the fee rate for execution of the function “SCAN” of the device “MFP” with the setting option “BASIC” using “MFP” is “1.00”. Put another way, the fee specified in the fee table T2 is applied as it is. However, the fee rate for execution of the function “SCAN” of the device “MFP” with the setting option “BASIC” using “SCANNER” is “0.85”.

The communication control unit 1007 reads out information representing the fee rate table T4. The fee calculation unit 1005 calculates a fee in the second stage by multiplying the fee rate in the fee rate table T4 by the fee specified in the fee table T2. The fee calculation unit 1005 of the main body section 11 calculates fees based on the fee rates in this manner.

A second modification of the billing system 1 is described below.

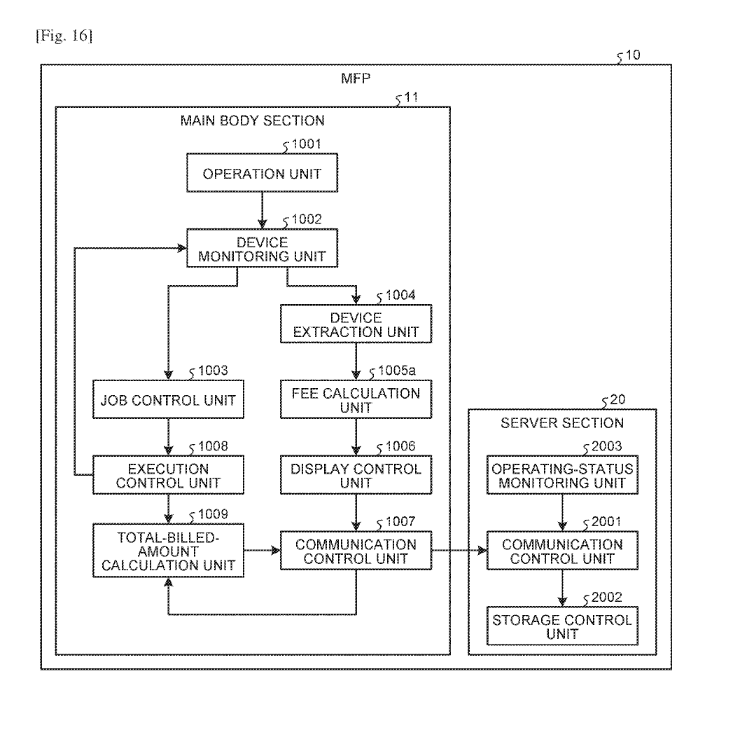

FIG. 16 is a block diagram illustrating an example of functional components of the main body section 11, the server section 20, the printer 30, and the scanner 40 of the second modification. The second modification differs from the embodiment in a fee calculation unit 1005a of the main body section 11, a fee calculation unit 3005a of the printer 30, and a fee calculation unit 4005a of the scanner 40. The server section 20 of the second modification differs from that of the embodiment in further including an operating-status monitoring unit 2003.

The operating-status monitoring unit 2003 of the server section 20 monitors operating statuses of each of the devices included in the billing system 1. The operating-status monitoring unit 2003 calculates operating rates per unit time of each of the devices included in the billing system 1. Furthermore, the operating-status monitoring unit 2003 generates operating status information indicating operating rates per unit time of each of the devices included in the billing system 1. The communication control unit 2001 transmits the operating status information to the devices included in the billing system 1 at regular intervals.

The fee calculation unit 1005a calculates fees using the received operating status information. More specifically, the fee calculation unit 1005a adjusts fees in the second stage so as to lower a fee(s) of a device(s) whose operating rate(s) is relative low. Hence, the operating-status monitoring unit 2003 can make the devices be used equally. Alternatively, the fee calculation unit 1005a may adjust fees so as to increase a fee(s) of a device(s) whose operating rate is relative high. The fee calculation unit 1005a may apply adjustment based on the fee rates to fees in the first stage or fees in the first stage.

In this case, the fee calculation units 3005 and 4005 of the printer 30 and the scanner 40 also calculate fees using the received operating status information as in the case of the fee calculation unit 1005a of the main body section 11.

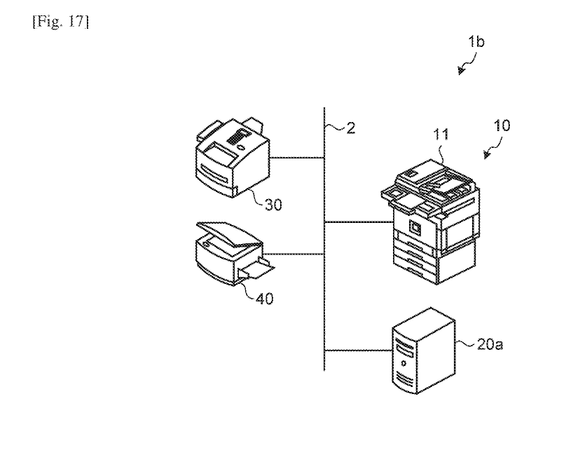

A third modification of the billing system 1 is described below. In the above description, the server section 20 is built in the MFP 10. Alternatively, the server section 20 may be separated from the MFP 10. FIG. 17 is a schematic diagram illustrating an example of a billing system 1b of the third modification. The server section 20 may be separated from the MFP 10 as a server apparatus 20a as illustrated in FIG. 17. In this case, the server section 20 may preferably connect the MFP 10, the printer 30, and the scanner 40 to devices via the network 2.

The foregoing description of the embodiments of the present invention has been provided for the sake of illustration and is not intended to limit the scope of the invention. These novel embodiments can be practiced in various other forms, and various omissions, substitutions, and changes can be made without departing from the gist of the invention. These embodiments and modifications thereof fall within the scope and gist of the invention and fall within the scope of the invention described the appended claims and their equivalents.

The foregoing embodiments are not intended to limit the scope of the present invention. The functions (the device monitoring unit 1002, 3002, 4002, the device extraction unit 1004, 3004, 4004, the fee calculation unit 1005, 3005, 4005, 1005a, 3005a, 4005a, and the total-billed-amount calculation unit 1009, 3009, 4009) included in the main body section 11 of the MFP 10, the printer 30, and the scanner 40 may alternatively be included in the server section 20.

The functions (the storage control unit 2002 and the operating-status monitoring unit 2003) included in the server section 20 may alternatively be included in the main body section 11 of the MFP 10, the printer 30, and the scanner 40. The information (the function table T1, the fee table T2, the billing information table T3, and the fee rate table T4) stored in the HDD 205 of in the server section 20 may alternatively be included in any one of the main body section 11 of the MFP 10, the printer 30, and the scanner 40.

The number of the devices, such as the MFP 10, the printer 30, and the scanner 40, included in the billing system 1 may be an arbitrary number. A device(s) of any type may be added or deleted from the devices. The billing system 1 may include a plurality of the server sections 20 or a plurality of the server apparatuses 20a. The configuration of the billing system 1 described in the embodiments are only an example and, needless to say, the billing system 1 can come in various system configurations that vary depending on a use and purpose.

The above-described functions of the parts (the operation unit 1001, the device monitoring unit 1002, the job control unit 1003, the device extraction unit 1004, the fee calculation unit 1005, 1005a, the display control unit 1006, the communication control unit 1007, the execution control unit 1008, and the total-billed-amount calculation unit 1009) of the main body section 11 are implemented by executing, by the CPU 101, the program stored in a storage device (e.g., the ROM 103 or the HDD 105). However, implementation is not limited thereto. For example, at least some of the functions of the parts of the main body section 11 may be implemented in a dedicated hardware circuit (e.g., a semiconductor integrated circuit).

The above-described functions of the parts (the communication control unit 2001, the storage control unit 2002, and the operating-status monitoring unit 2003) of the server section 20 are implemented by executing, by the CPU 201, the program stored in a storage device (e.g., the ROM 203 or the HDD 205). However, implementation is not limited thereto. For example, at least some of the functions of the parts of the server section 20 may be implemented in a dedicated hardware circuit (e.g., a semiconductor integrated circuit).

The above-described functions of the parts (the operation unit 3001, the device monitoring unit 3002, the job control unit 3003, the device extraction unit 3004, the fee calculation unit 3005, 3005a, the display control unit 3006, the communication control unit 3007, the execution control unit 3008, and the total-billed-amount calculation unit 3009) of the printer 30 are implemented by executing, by the CPU 301, the program stored in a storage device (e.g., the ROM 303 or the HDD 305). However, implementation is not limited thereto. For example, at least some of the functions of the parts of the printer 30 may be implemented in a dedicated hardware circuit (e.g., a semiconductor integrated circuit).

The above-described functions of the parts (the operation unit 4001, the device monitoring unit 4002, the job control unit 4003, the device extraction unit 4004, the fee calculation unit 4005, 4005a, the display control unit 4006, the communication control unit 4007, the execution control unit 4008, and the total-billed-amount calculation unit 4009) of the scanner 40 are implemented by executing, by the CPU 401, the program stored in a storage device (e.g., the ROM 403 or the HDD 405). However, implementation is not limited thereto. For example, at least some of the functions of the parts of the scanner 40 may be implemented in a dedicated hardware circuit (e.g., a semiconductor integrated circuit).

The program P1, the program P2, the program P3, and the program P4 to be executed by the main body section 11, the server section 20, the printer 30, and the scanner 40 of the present embodiment may be provided by being recorded in a non-transitory computer-readable recording medium, such as CD-ROM, a flexible disk (FD), a CD-R, or a DVD (digital versatile disk), as an installable file or an executable file.

The program P1, the program P2, the program P3, and the program P4 to be executed by the main body section 11, the server section 20, the printer 30, and the scanner 40 of the present embodiment may be configured to be stored in a computer connected to a network, such as the Internet, and provided by being downloaded over the network.

The program P1, the program P2, the program P3, and the program P4 to be executed by the main body section 11, the server section 20, the printer 30, and the scanner 40 of the present embodiment may be configured to be provided or delivered via a network, such as the Internet. The program P1, the program P2, the program P3, and the program P4 to be executed by the main body section 11, the server section 20, the printer 30, and the scanner 40 of the present embodiment may be configured to be provided as being stored in the ROM 103, 203, 303, 403, or the like in advance.

### REFERENCE SIGNS LIST

1 Billing system
10 MFP
11 Main body section
20 Server section
30 Printer
40 Scanner
1001, 3001, 4001 Operation unit
1002, 3002, 4002 Device monitoring unit
1003, 3003, 4003 Job control unit
1004, 3004, 4004 Device extraction unit
1005, 1005a, 3005, 3005a, 4005, 4005a Fee calculation unit
1006, 3006, 4006 Display control unit
1007, 3007, 4007 Communication control unit
1009, 3009, 4009 Total-billed-amount calculation unit
2001 Communication control unit
2002 Storage control unit
2003 Operating-status monitoring unit
T1 Function table
T2 Fee table
T3 Billing information table
T4 Fee rate table

### CITATION LIST

### Patent Literature

[PTL 1]

Japanese Unexamined Patent Publication No. 2005-338377

1. A billing system comprising:
an operation unit configured to receive an operation for executing a function provided by one device of a plurality of devices;
a determination unit configured to determine whether the one device is available for the function associated with the operation received by the operation unit;
an extraction unit configured to extract another device that is available for the function as a substitute for the one device when the determination unit determines that the one device is not available for the function;
a first calculator configured to calculate a fee for the function to be executed by the other device; and
a second calculator configured to calculate a total billed amount based on the fee calculated by the first calculator and content executed by the other device when the function is executed by the other device as the substitute for the one device.

2. The billing system according to claim 1, wherein
the operation unit receives an operation for designating the function and an execution condition for executing the function, and
the extraction unit extracts the other device that is available for the function as a substitute for the one device even when the execution condition is not applicable to the other device.

3. The billing system according to claim 2, wherein the first calculator calculates the fee to a value lower than a fee for execution of the function with the execution condition applied thereto when the execution condition is not applicable to the other device.

4. The billing system according to claim 2, wherein the first calculator calculates the fee based on a fee rate determined in advance for each execution condition.

5. The billing system according to claim 1, further comprising a display controller configured to display a selection screen for selecting the other device executing the function as the substitute for the one device from one or more other devices extracted by the extraction.

6. The billing system according to claim 5, wherein the display controller causes indication, for each of the other devices, as to whether a larger number of execution conditions are applicable to the other device than to the one device to be displayed on the selection screen.

7. The billing system according to claim 2, wherein the first calculator calculates a fee for each other device depending on the number of execution conditions for the each other device.

8. The billing system according to claim 1, further comprising a server apparatus including a monitoring unit configured to monitor an operating rate of each other device, wherein the first calculator calculates the fee for each other device depending on the operating rate of the each other device monitored by the monitoring unit.

9. A billing method comprising:
receiving an operation for executing a function provided by one device of a plurality of devices;
determining whether the one device is available for the function associated with the received operation;
extracting another device that is available for the function as a substitute for the one device when the one device is determined not to be available for the function;
calculating a fee for the function to be executed by the other device; and
calculating a total billed amount based on the calculated fee and content executed by the other device when the function is executed by the other device as the substitute for the one device.

10. A non-transitory recording medium containing program with an executable program stored thereon, wherein the program instructs a computer to perform:
receiving an operation for executing a function provided by one device of a plurality of devices;
determining whether the one device is available for the function associated with the received operation;
extracting another device that is available for the function as a substitute for the one device when the one device is determined not to be available for the function;
calculating a fee for the function to be executed by the other device; and
calculating a total billed amount based on the calculated fee and content executed by the other device when the function is executed by the other device as the substitute for the one device.
